(19) United States
(12) Patent Application Publication
(10) Pub. No.: US 2026/0329292 A1
(43) Pub. Date: Oct. 22, 2026

(54) OBSTACLE DETECTING APPARATUS, OBSTACLE DETECTING METHOD, AND NON-TRANSITORY COMPUTER-READABLE STORAGE MEDIUM

(71) Applicant: NEC Corporation, Minato-ku, Tokyo (JP)

(72) Inventors: Nagma Samreen KHAN, Tokyo (JP); Jiro ABE, Tokyo (JP); Kazumine OGURA, Tokyo (JP)

(73) Assignee: NEC Corporation, Minato-ku, Tokyo (JP)

(21) Appl. No.: 19/104,724

(22) PCT Filed: Aug. 31, 2022
(86) PCT No.: PCT/JP2022/032726

§ 371 Date: Feb. 19, 2025

(51) Int. Cl. G05D 1/622; G05B 19/4155; G05D 105/10

(52) U.S. Cl. CPC G05D 1/622; G05B 19/4155; G05B 2219/40455; G05D 2105/10

(57) ABSTRACT

An obstacle detecting apparatus is configured to: acquire a position data set that includes a plurality of position data that indicates a three-dimensional position of a point of a target place; detect, from the position data set, a first subset that includes a plurality of the position data that collectively represent a ground of the target place; determine a vertical position of the ground based on vertical positions indicated by the plurality of position data in the first subset; detect one or more objects from the position data set to generate an obstacle candidate set; compute, for each object in the obstacle candidate set, a height of the object based on a vertical position of the object and the vertical position of the ground; and exclude the object whose height is larger than a height threshold from the obstacle candidate set.

### TECHNICAL FIELD

The present disclosure generally relates to obstacle detecting apparatus, obstacle detecting method, and non-transitory computer-readable storage medium.

### BACKGROUND ART

Computer systems that detect obstacles using a set of position data (e.g., a LiDAR-derived image or a depth image) indicating positions of points of a place has been developed. PTL1 discloses a problem that it is difficult for a cleaning robot to detect small objects, and provides a technique with which a cleaning robot can detect small objects using a 3D point cloud. PTL2 discloses a method to detect obstacles on a road using a 3D point cloud.

### CITATION LIST

### Patent Literature

PTL1: European Patent Publication No. 3825903
PTL2: US Patent Publication No. 2020/0012869

### SUMMARY OF INVENTION

### Technical Problem

Regarding PTL1, it is obvious that cleaning robots have to detect any obstacles that hinder their travel. Thus, the cleaning robots are required to detect not only small objects but also non-small objects as obstacles. The method disclosed by PTL2 does not take the heights of obstacles into consideration. An objective of the present disclosure is to provide a novel technique to detect obstacles using a set of position data.

### Solution to Problem

The present disclosure provides an obstacle detecting apparatus that comprises at least one memory that is configured to store instructions and at least one processor.

The at least one processor is configured to execute the instructions to: acquire a position data set that includes a plurality of position data that indicates a three-dimensional position of a point of a target place; detect a first subset from the position data set, the first subset including a plurality of the position data that collectively represent a ground of the target place; determine a vertical position of the ground based on vertical positions indicated by the plurality of position data in the first subset; detect one or more objects from the position data set to generate an obstacle candidate set; compute, for each object in the obstacle candidate set, a height of the object based on a vertical position of the object and the vertical position of the ground; and exclude the object whose height is larger than a height threshold from the obstacle candidate set.

The present disclosure further provides an obstacle detecting method that comprises: acquiring a position data set that includes a plurality of position data that indicates a three-dimensional position of a point of a target place; detecting a first subset from the position data set, the first subset including a plurality of the position data that collectively represent a ground of the target place; determining a vertical position of the ground based on vertical positions indicated by the plurality of position data in the first subset; detecting one or more objects from the position data set to generate an obstacle candidate set; computing, for each object in the obstacle candidate set, a height of the object based on a vertical position of the object and the vertical position of the ground; and excluding the object whose height is larger than a height threshold from the obstacle candidate set.

The present disclosure further provides a non-transitory computer readable storage medium storing a program. The program that causes a computer to execute: acquiring a position data set that includes a plurality of position data that indicates a three-dimensional position of a point of a target place; detecting a first subset from the position data set, the first subset including a plurality of the position data that collectively represent a ground of the target place; determining a vertical position of the ground based on vertical positions indicated by the plurality of position data in the first subset; detecting one or more objects from the position data set to generate an obstacle candidate set; computing, for each object in the obstacle candidate set, a height of the object based on a vertical position of the object and the vertical position of the ground; and excluding the object whose height is larger than a height threshold from the obstacle candidate set.

### Advantageous Effects of Invention

According to the present disclosure, a novel technique to detect obstacles using a set of position data is provided.

### BRIEF DESCRIPTION OF DRAWINGS

FIG. 1 illustrates an overview of an obstacle detecting apparatus of the first example embodiment.

FIG. 2 is a block diagram showing an example of the functional configuration of the obstacle detecting apparatus of the first example embodiment.

FIG. 3 is a block diagram illustrating an example of the hardware configuration of a computer realizing the obstacle detecting apparatus of the first example embodiment.

FIG. 4 shows a flowchart illustrating an example flow of process performed by the obstacle detecting apparatus of the first example embodiment.

FIG. 5 illustrates an example case of dividing the ground into sections based on the section height.

FIG. 6 illustrates an example case of dividing the ground into sections in top view using a predefined window.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predefined information (e.g., a predefined value or a predefined threshold) is stored in advance in a storage unit to which a computer using that information has access unless otherwise described. In the present disclosure, a storage unit may be implemented with one or more storage devices, such as hard disks, solid-state drives (SSDs), or random-access memories (RAMs).

### First Example Embodiment

### <Overview>

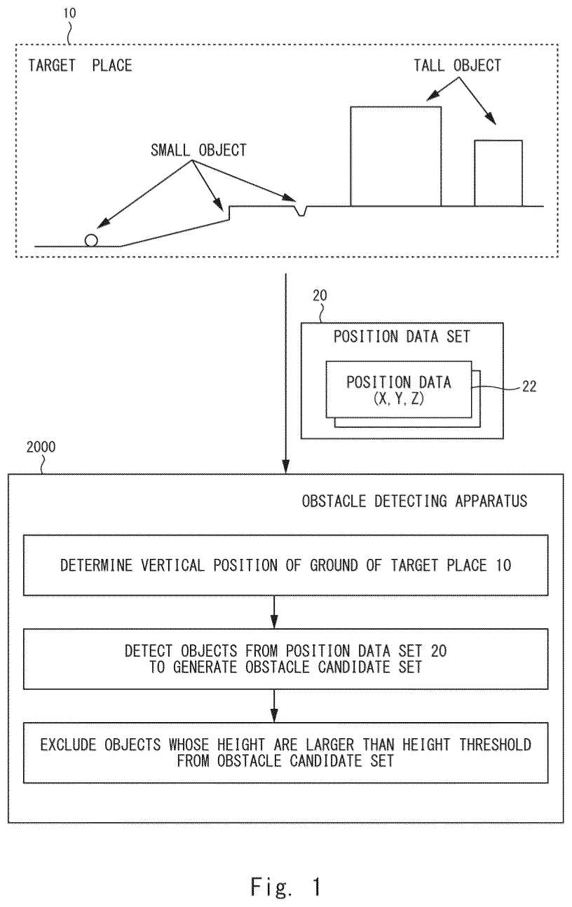

FIG. 1 illustrates an overview of an obstacle detecting apparatus 2000 of the first example embodiment. It is noted that FIG. 1 does not limit operations of the obstacle detecting apparatus 2000, but merely show an example of possible operations of the obstacle detecting apparatus 2000.

The obstacle detecting apparatus 2000 is an apparatus that is configured to detect one or more obstacles in a target lace 10 that tend to be easily out of human's sight. Such obstacles are small objects whose height are not larger a predefined threshold: e.g., 10 cm, 50 cm, 1 m, etc. Examples of an small object may be a step or a pipe which is placed on a ground of the target place 10. Since small objects tend to be easily out of human's sight and can cause an accident (e.g., falling down), it is preferable to facilitate a person to notice those small objects. Hereinafter, a candidate of obstacle to be detected may be called “obstacle candidate”. On the other hand, objects that are not so small (e.g., a wall, a building, or machinery) tend to be easily in the sight of human, and thus people can easily notice them without help of a computer system.

Thus, the obstacle detecting apparatus 2000 handles the objects on the ground of the target place 10 whose height are larger than the predefined threshold as outliers, and exclude them from obstacle candidates. To do so, the obstacle detecting apparatus 2000 may operate as follows.

The obstacle detecting apparatus 2000 acquires a position data set 20. The position data set 20 includes a plurality of position data 22. The position data 22 indicates a three-dimensional (3D) position of a point of the target place 10. In some implementations, the position data set 20 may be called “3D point cloud”.

The obstacle detecting apparatus 2000 detects a ground of the target place 10 from the position data set 20. Specifically, the obstacle detecting apparatus 2000 detects a first subset from the position data set 20. The first subset is a subset of the position data set 20 and includes a plurality of the position data 22 that collectively represent the ground of the target place 10.

The ground of the target place 10 is a surface of land in the target place 10 on which a person moves. The ground may be located inside a building or outside a building. In the former case, the ground may be a floor of an indoor facility: e.g., a factory or an office. In the latter case, the ground may be a ground of an outdoor facility: e.g., a substation.

The obstacle detecting apparatus 2000 determines a vertical position (or level) of the ground. In some embodiments, the obstacle detecting apparatus 2000 computes a statistical value of vertical positions of the position data 22 (e.g., a z-coordinate indicated by the position data 22) included in the first subset, as the vertical position of the ground. Hereinafter, a vertical position of the ground may also be called “ground level”.

The obstacle detecting apparatus 2000 detects objects from the position data set 20 to generate a set of obstacle candidate, called “obstacle candidate set”.

Specifically, the obstacle detecting apparatus 2000 detects one or more second subsets from the position data set 20. The second subset is a subset of the position data set 20 and includes a plurality of position data 22 that collectively represent an object. The obstacle candidate set may be a collection of the second subsets.

For each object in the obstacle candidate set, the obstacle detecting apparatus 2000 computes the height of the object based on the ground level and the vertical position of the object. For example, the obstacle detecting apparatus 2000 may compute the difference between the vertical position of the object and the ground level as the height of the object. It is noted that the vertical position of an object may be the highest vertical position of all the position data 22 in the second subset corresponding to the object.

For each object in the obstacle candidate set, the obstacle detecting apparatus 2000 determines whether or not the height of the object is larger than a predefined threshold called “height threshold”. When the height of the object is determined to be larger than the height threshold, the obstacle detecting apparatus 2000 excludes that object from the obstacle candidate set. This means that the object whose height is determined to be larger than the height threshold is handled as an outlier. On the other hand, when the height of the object is determined to be not larger than the height threshold, the obstacle detecting apparatus 2000 does not exclude that object from the obstacle candidate set.

### Example of Advantageous Effect

In some places, such as factories or substations, it is important to ensure safety of workers from obstacles that can cause accidents. Thus, it is helpful for workers to be provided with alerts when, for example, they are approaching obstacles.

However, workers can easily notice tall objects, such as walls or machinery, and do not need an alert to notice them. Furthermore, if even tall objects are handled as obstacles, workers may receive too many alerts and their work may be distracted by the alerts. Thus, it is preferable and effective to handle only small objects as obstacles in some situations.

As mentioned above, the obstacle detecting apparatus 2000 excludes the objects whose height are larger than the height threshold from the obstacle candidate set. As a result of this exclusion, all the objects included in the obstacle candidate set are not higher than the height threshold. Thus, by performing obstacle detection on the obstacle candidate set, it is possible to detect obstacles whose height are not larger than the height threshold. In addition, it is possible to handle only small objects as targets of alerts, thereby providing effective alerts to people while preventing the people from being distracted by less effective alerts.

Furthermore, the obstacle detecting apparatus 2000 determines the vertical level of the ground of the target place 10 based on the position data set 20 to compute the height of objects. Thus, the obstacle detecting apparatus 2000 needs not to be provided with a height of a sensor (e.g., a LiDAR device or a depth camera) that is used to generate the position data set 20.

Hereinafter, more detailed explanation of the obstacle detecting apparatus 2000 will be described.

### Example of Functional Configuration

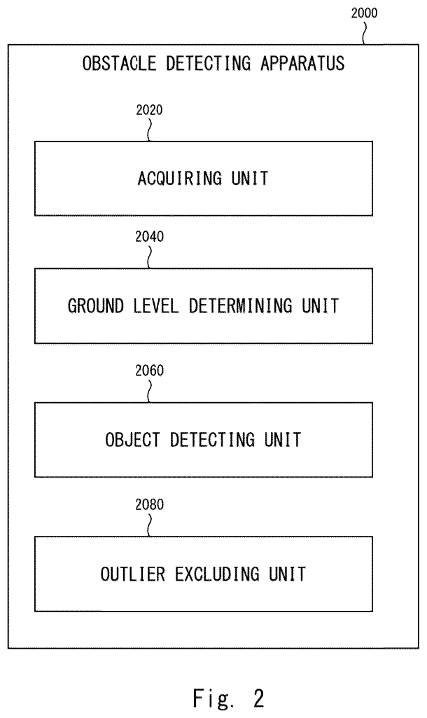

FIG. 2 is a block diagram showing an example of the functional configuration of the obstacle detecting apparatus 2000 of the first example embodiment. The obstacle detecting apparatus 2000 includes an acquiring unit 2020, a ground level determining unit 2040, an object detecting unit 2060, and an outlier excluding unit 2080.

The acquiring unit 2020 acquires a position data set 20. The ground level determining unit 2040 detects the ground of the target place 10 from the position data set 20 and determines the ground level. The object detecting unit 2060 detects one or more objects from the position data set 20 to generate the obstacle candidate set. For each object, the outlier excluding unit 2080 computes the height of the object and determines whether or not the height of the object is larger than the height threshold. The outlier excluding unit 2080 exclude the object whose height is determined to be larger than the height threshold from the obstacle candidate set.

### Example of Hardware Configuration

The obstacle detecting apparatus 2000 may be realized by one or more computers. Each of the one or more computers may be a special-purpose computer manufactured for implementing the obstacle detecting apparatus 2000, or may be a general-purpose computer like a personal computer (PC), a server machine, or a mobile device.

The obstacle detecting apparatus 2000 may be realized by installing an application in the computer. The application is implemented with a program that causes the computer to function as the obstacle detecting apparatus 2000. In other words, the program is an implementation of the functional units of the obstacle detecting apparatus 2000. There are various ways to acquire the program. For example, the program can be acquired from a storage medium (such as a DVD disk or a USB memory) in which the program is stored in advance. In another example, the program can be acquired by downloading it from a server machine that manages a storage medium in which the program is stored in advance.

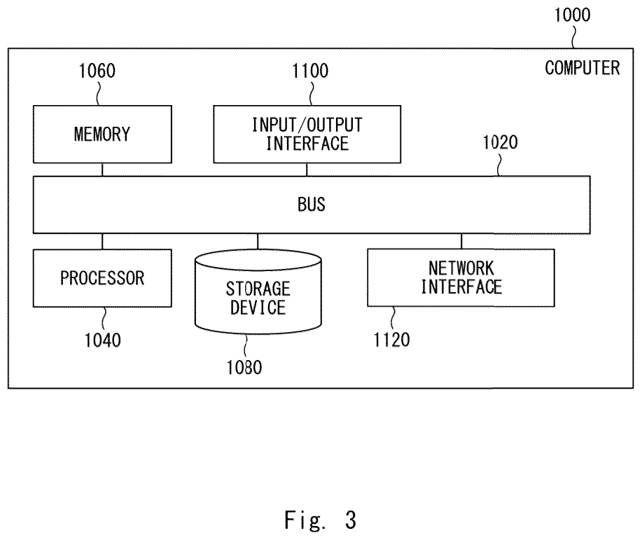

FIG. 3 is a block diagram illustrating an example of the hardware configuration of a computer 1000 realizing the obstacle detecting apparatus 2000 of the first example embodiment. In FIG. 3, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, the I/O interface 1100, and the network interface 1120 to mutually transmit and receive data. The processor 1040 is a processer, such as a CPU (Central Processing Unit), GPU (Graphics Processing Unit), FPGA (Field-Programmable Gate Array), or a DSP (Digital Signal Processor). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, a mouse, or a display device. The network interface 1120 is an interface between the computer 1000 and a network. The network may be a LAN (Local Area Network) or a WAN (Wide Area Network). The storage device 1080 may store the program mentioned above. The processor 1040 executes the program to realize each functional unit of the obstacle detecting apparatus 2000.

The hardware configuration of the computer 1000 is not restricted to that shown in FIG. 3. For example, as mentioned-above, the obstacle detecting apparatus 2000 may be realized by plural computers. In this case, those computers may be connected with each other through the network.

### <Flow of Process>

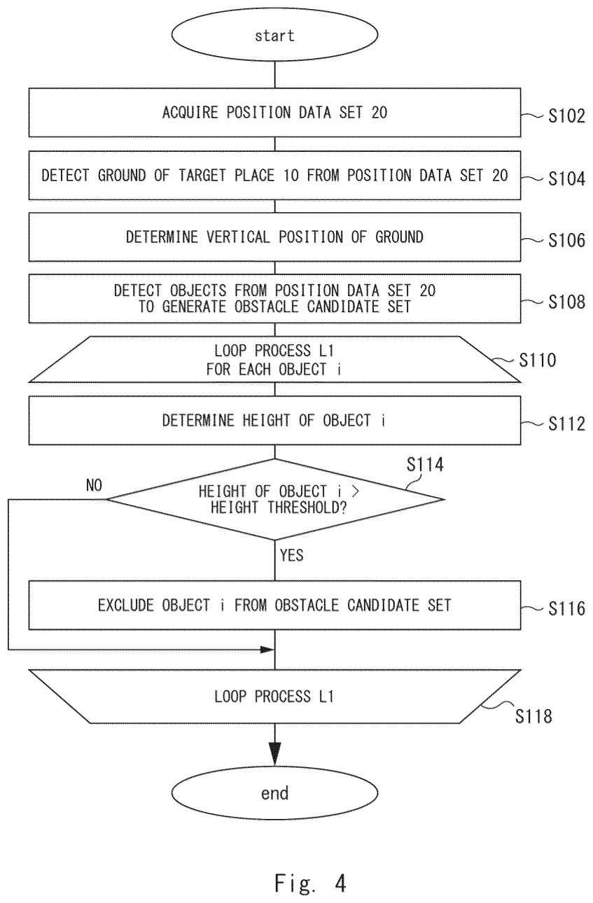

FIG. 4 shows a flowchart illustrating an example flow of process performed by the obstacle detecting apparatus 2000 of the first example embodiment. The acquiring unit 2020 acquires the position data set 20 (S102). The ground level determining unit 2040 detects the ground of the target place 10 from the position data set 20 (S104). The ground level determining unit 2040 determines the ground level (S106). The object detecting unit 2060 detects one or more objects from the position data set 20 to generate the obstacle candidate set (S108).

Steps S110 to S118 constitutes a loop process L1 that is performed for each object in the obstacle candidate set. In the Step S110, the obstacle detecting apparatus 2000 determines whether or not the loop process L1 has been performed for all the objects in the obstacle candidate set. When the loop process L1 has been performed for all the objects in the obstacle candidate set, the detecting apparatus 2000 terminates the loop process L1. As a result, the process shown by FIG. 4 is terminated. On the other hand, when the loop process L1 has not been performed for all the objects in the obstacle candidate set yet, the detecting apparatus 2000 chooses one of the objects for which the loop process L1 is not performed yet. The object chosen here is denoted by “object i”.

The outlier excluding unit 2080 computes the height of the object i (S112). The outlier excluding unit 2080 determines whether or not the height of the object i is larger than the height threshold (S114). When the height of the object is larger than the height threshold (S114: YES), the outlier excluding unit 2080 excludes the object i from the obstacle candidate set (S116). On the other hand, when the height of the object is not larger than the height threshold (S114: NO), the object i is not excluded from the object candidate set. The step S118 is the end of the current iteration of the loop process L1. Thus, the step S110 is performed again.

After the iterative execution of the loop process L1 is terminated, the obstacle detecting apparatus 2000 can obtain the set of obstacle candidate that includes only the objects whose height are not larger than the height threshold.

The flow of process performed by the obstacle detecting apparatus 2000 is not limited to one shown by FIG. 4. For example, the detection of the ground (S104) and the determination of the ground level (S106) may be performed after or in parallel with the detection of objects (S108).

### <Acquisition of Position Data Set 20: S102>

The acquiring unit 2020 acquires the position data set 20 (S102). There are various ways to acquire the position data set 20. In some implementations, the acquiring unit 2020 may receive the position data set 20 that is sent from another computer, such as one that generates the position data set 20. In other implementations, the position data set 20 may be stored in advance in a storage unit to which the acquiring unit 2020 has access. In this case, the acquiring unit 2020 reads the position data set 20 out of this storage unit.

There are various well-known ways to generate a set of data that indicates a position of a point of place, such as 3D point cloud, and one of those ways may be used to generate the position data set 20. For example, the position data set 20 may be generated by measuring a plurality of points of the target place 10 with a sensor device that measures the distance from it to points in a scene (e.g., a LiDAR device or a depth camera).

### <Detection of Ground: S104>

The ground level determining unit 2040 detects the ground of the target place 10 from the position data set 20 (S104). Specifically, as mentioned above, the ground level determining unit 2040 detects, as the first subset, a set of the position data 22 that collectively represent the ground of the target place 10 from the position data set 20. There are various well-known ways to detect a subset of position data that collectively represent the ground from a set of position data (e.g., 3D point cloud), and one of those ways can be applied to the ground level determining unit 2040.

For example, the ground level determining unit 2040 may perform segmentation on the position data set 20, thereby dividing the position data set 20 to a plurality of subsets each of which includes a plurality of the position data 22 that collectively represent a region of the target place 10. It is noted that a region of the target place 10 is a part of the target place 10 existing in a real world that is collectively represented by a plurality of the position data 22 corresponding to that region. Then, the ground level determining unit 2040 chooses one of the subsets that meets a predefined characteristics of the ground as the first subset.

The predefined characteristics of the ground may include: (1) a normal direction of the region represented by the subset is substantially parallel to the vertical direction; and (2) a size of the region represented by the subset is the largest of all the regions that have the characteristics (1). It is noted that there are various well-known ways to determine a normal vector of a region represented by a set of position data, and one of those ways can be applied to the ground level determining unit 2040.

It is noted that whether or not the normal direction of a region is substantially parallel to the vertical direction may be determined based on an angle A between the normal direction of the region and the vertical direction. Specifically, when |A|<Th1, it is determined that the normal direction of the region is substantially parallel to the vertical direction. Th1 is a predefined threshold and may be set to be substantially close to zero. On the other hand, when |A|>=Th1, it is determined that the normal direction of the region is not substantially parallel to the vertical direction.

It is also noted that the normal direction of the region may be computed using a set of position data 22 that collectively represent the region. For example, the ground level determining unit 2040 may determine a plane that fits the set of the position data 22 that collectively represent the region, and compute the normal direction of the plane as the normal direction of the region.

In the example mentioned above, one of the subsets that meets a predefined characteristics of the ground is chosen as the first subset. However, in another example, the ground level determining unit 2040 may choose two or more subsets that meets a predefined characteristics of the ground, and merge them into one to provide it as the first subset. In this case, the predefined characteristics of the ground may include: (1) a normal direction of the region represented by the subset is substantially parallel to the vertical direction; and (2) a size of the region represented by the subset is larger than a predefined value. The one or more subsets which fulfil these characteristics are chosen as belonging to first subset. In this case, the one or more subsets are merged into one and provided as first subset, i.e. ground.

In another example, the ground level determining unit 2040 performs semantic segmentation on the position data 22. In this case, one of predefined classes is assigned to each subset of the position data set 20 that collectively represent a region of the target place 10. Thus, the ground level determining unit 2040 can determine the subset to which the class “ground” is assigned as the first subset.

It is noted that there are various well-known ways to perform semantic segmentation on a set of position data, and one of those ways can be applied to the ground level determining unit 2040. For example, the ground level determining unit 2040 may include a machine learning-based model, such as a neural network, that is configured to take a set of position data 22 as input and that is learnt to determine the class to which a region represented by the input data belongs.

### <Determination of Ground Level: S106>

The ground level determining unit 2040 determines the ground level (i.e., the vertical position of the ground) (S106). In some embodiments, the ground level determining unit 2040 may compute a statistical value of the vertical position of the position data 22 included in the first subset, which is, as mentioned above, the set of the position data 22 that collectively represent the ground of the target place 10. It is noted that there are various types of statistical value that can be used to compute the ground level: e.g., mean, maximum, minimum, or mode.

When mean is employed as the type of the statistical value, the ground level may be computed as follows:

$$\begin{matrix}Expression 1 & \\ g = \frac{1}{\vert F \vert} * {\sum }_{p ∈ F} v ( p ) & ( 1 )\end{matrix}$$

where g represents the ground level; F represents the first subset; |F| represents the cardinality of the first subset; p represents a position data 22; and v(p) represents the vertical position (e.g., z coordinate) indicated by the position data p.

It is possible that the ground of the target place 10 includes two or more areas whose levels are substantially different from each other. Thus, the ground level determining unit 2040 may determine two or more ground levels for the ground of the target place 10. Specifically, the ground level determining unit 2040 may divide the ground of the target place 10 into two or more sections, and determine the ground level for each section.

To divide the ground into two or more sections, the ground level determining unit 2040 divides the first subset into two or more subsets each of which collectively represents a section of the ground. Then, the ground level determining unit 2040 may compute, for each section, the statistical value of the vertical position of the position data 22 included in the subset of the first subset that collectively represents the corresponding section. When mean is employed as the type of the statistical value, the ground level of a section may be computed as follows:

$$\begin{matrix}Expression 2 & \\ {g}_{i} = \frac{1}{\vert {F}_{i} \vert} * {\sum }_{p ∈ {F}_{i}} v ( p ) & ( 2 )\end{matrix}$$

where g_i represents the ground level of the i-th section of the ground; and F_i represents the subset of the first subset whose position data 22 collectively represent the i-th section of the ground. The other notations are in common with the expression (1).

There are various ways to divide the ground into sections. Hereinafter, some examples thereof will described.

### Example 1

The ground level determining unit 2040 may use a predefined height of section, called “section height” to divide the ground into sections. The section height specifies a height of the section: i.e., difference between the lowest vertical position and the highest vertical position in a single section.

Suppose that the level of the position data p_1 at the lowest level included in the first subset is v(p_1), and the level of the position data p_h at highest level included in the first subset is v(p_h). In addition, the section height is set to be S. In this case, the ground level determining unit 2040 may divide the rage of the vertical positions of the ground [v(p_1), v(p_h)] with the interval S, thereby obtaining the rages of vertical position {R1:[v(p_1), v(p_1)+S], R2:[v(p_1)+S, v(p_1)+2S], . . . , Rn:[v(p_1)+ (n−1)*S, v(p_h)]}; n is the number of the obtained ranges. In some implementations, the interval S may be defined based on the height threshold: e.g., S=α*HT (0<<<1) where HT represents the height threshold.

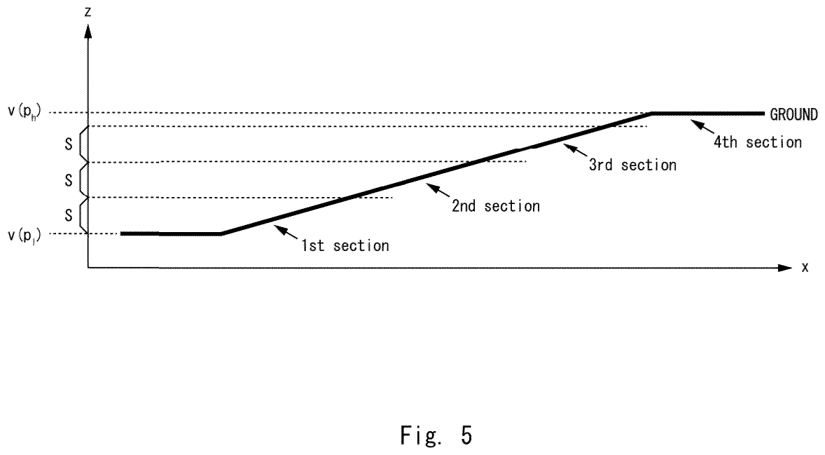

FIG. 5 illustrates an example case of dividing the ground into sections based on the section height. In FIG. 5, the range of the vertical position of the ground is divided into four ranges:[v(p_1), v(p_1)+S], [v(p_1)+S, v(p_1)+2S], [v(p_1)+2S, v(p_1)+3S], and [v(p_1)+3S, v(p_h)]. Thus, the ground is divided into four sections.

For each position data 22 in the first subset, the ground level determining unit 2040 assigns one of the ranges of vertical position in which the vertical position of the position data 22 is included, thereby dividing the first subset into sections.

### Example 2

The ground level determining unit 2040 may divide the ground into sections in top view using a predefined window. For example, the predefined window may be set in advance to have a rectangle shape with a predefined x-direction length of W and a y-direction length of H. In this case, the ground is divided into two or more sections that have a rectangle shape with the x-direction length of W and the y-direction length of H in top view.

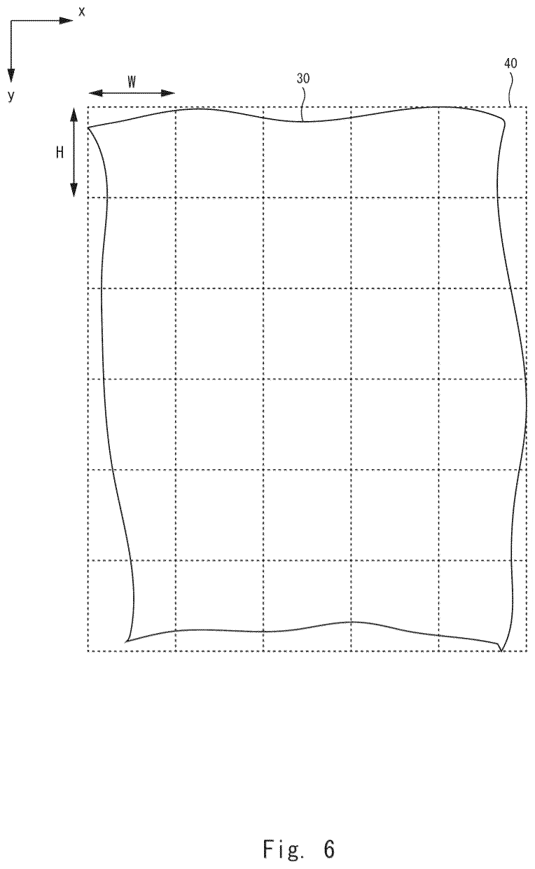

FIG. 6 illustrates an example case of dividing the ground into sections in top view using a predefined window. In FIG. 6, the ground 30 is divided into 5×6 sections using the predefined window 40.

### Example 3

The ground level determining unit 2040 may divide the ground into sections based on its class (or type): e.g., flat section, up-slope section, down-slope section, etc. To do so, the ground level determining unit 2040 may perform semantic segmentation on the first subset to divide them into two or more subsets based on classes of section. As mentioned above, there are various well-known ways to perform semantic segmentation on a set of position data, and one of those ways can be applied to the ground level determining unit 2040 to perform semantic segmentation to divide the ground into sections.

### <Detection of Object: S108>

The object detecting unit 2060 detects one or more objects from the position data set 20 (S108). Specifically, the object detecting unit 2060 detects one or more subsets of the position data set 20 (i.e., the second subsets) to generate the obstacle candidate set in which the detected second subsets are included. As mentioned above, the second subset includes a plurality of position data 22 that collectively represent an object other than the ground. There are various ways to detect objects from a set of position data, and one of those ways can be applied to the object detecting unit 2060.

The obstacle detecting apparatus 2000 may detect objects from a whole of the position data set 20 or a part of the position data set 20. In the latter case, the obstacle detecting apparatus 2000 may determine a part of the position data set 20 as a target of object detection. In some case, the target place 10 includes one or more areas into which the persons cannot enter (e.g., areas occupied by machinery). Small objects located in those areas may not have to be detected for the purpose of providing an alert to a person in response to the person being approaching them.

Thus, the object detecting unit 2060 may determine a partial area of the target place 10, called “target area”, as a target of object detection. For example, the object detecting unit 2060 may determine a range of area in top-view into which persons may enter. This range of area may be defined by a pair of a range in x direction [x_min, x_max] and a range in y direction [y_min, y_max]. In this case, the object detecting unit 2060 extracts, from the position data set 20, all the position data 22 whose x positions are between x_min and x_max and whose y positions are between y_min and y_max to obtain a set of position data 22 that are included in the target area. Then, the object detecting unit 2060 detects objects from this set of position data 22.

The target area may be defined based on a range of the ground of the target place 10 in top view. For example, the smallest x position and the largest x position of the position data 22 included in the first subset are set to x_min and x_max, respectively. Similarly, the smallest y position and the largest y position of the position data 22 included in the first subset are set to y_min and y_max, respectively.

The object detecting unit 2060 may add a buffer to the target area. Suppose that the smallest x position and the largest x position of the position data 22 included in the first subset are x1 and x2, respectively. In this case, the object detecting unit 2060 may respectively set x1−b1 and x2+b1 to x_min and x_max wherein b1 is a buffer size in x direction. Similarly, suppose that the smallest y position and the largest y position of the position data 22 included in the first subset are y1 and y2, respectively. In this case, the object detecting unit 2060 may respectively set y1−b2 and y2+b2 to y_min and y_max wherein b2 is a buffer size in y direction.

### <Exclusion of Outliers: S112, S114, and S116>

The outlier excluding unit 2080 excludes one or more outliers from the obstacle candidate set. Specifically, for each object in the obstacle candidate set, the outlier excluding unit 2080 computes the height of the object (S112), determine whether or not the height of the object is larger than the height threshold (S114), and exclude the object (more specifically, the second subset corresponding to the object) from the obstacle candidate set when the height of the object is determined to be larger than the height threshold (S116).

The height of the object can be represented by an absolute value of the difference between the vertical position of the object and the ground level.

Suppose that the vertical position of the object is Vo and the ground level is Vg. In this case, the height of the object is an absolute value of the difference between Vo and Vg, which may be denoted by |Vo−Vg|. When Vo>Vg, the object is an elevated object: e.g., a step or pipe. On the other hand, when Vo<Vg, the object may be a depression: e.g., a hole or a drain path. It is noted that, when Vo<Vg, the height of the object may also be called the “depth” of the object.

As mentioned above, the ground level may be determined for two or more sections of the ground. In this case, the outlier excluding unit 2080 computes the height of the object based on the vertical position of the section corresponding to the object. Specifically, for each object, the outlier excluding unit 2080 determines the section that corresponds to the object. The section that corresponds to an object is one on which that object is located. Then, the outlier excluding unit 2080 computes the height of the object based on the vertical position of the determined section and that of the object.

### <Obstacle Detection>

After excluding outliers from the obstacle candidate set, the obstacle detecting apparatus 2000 may determine, for each object in the obstacle candidate set, whether or not the object is obstacle. Since non-small objects (i.e., objects whose height are larger than the height threshold) are excluded from the obstacle candidate set before determining whether or not an object is obstacle, it is possible to prevent non-small objects from being detected as obstacles.

There may be various ways to determine whether or not an object is obstacle. In some implementations, for each object, the obstacle detecting apparatus 2000 may compute a normal direction of the object, and determine whether or not the normal direction of the object is substantially perpendicular to the vertical direction. When the normal direction of the object is determined to be substantially perpendicular to the vertical direction, the obstacle detecting apparatus 2000 determines that the object is obstacle. On the other hand, when the normal direction of the object is determined to be not substantially perpendicular to the vertical direction, the obstacle detecting apparatus 2000 determines that the object is not obstacle.

It is noted that whether or not the normal direction of the object is substantially perpendicular to the vertical direction may be determined based on an angle B between the normal direction of the object and the vertical direction. Specifically, when |B−90°|<Th2, it is determined that the normal direction of the object is substantially perpendicular to the vertical direction. Th2 is a predefined threshold and may be set to be substantially close to zero. On the other hand, |B−90°|>=Th2, it is determined that the normal direction of the object is not substantially perpendicular to the vertical direction.

It is also noted that the normal direction of an object may be computed using the second subset corresponding to the object. For example, the object detecting apparatus 2000 may determine a plane of the object based on distribution of the position data 22 in the second subset corresponding to the object, and compute the normal direction of the plane as the normal direction of the object.

<Output from Obstacle Detecting Apparatus>

The obstacle detecting apparatus 2000 may output information, called “output information”, that is related to a result of the process performed by the obstacle detecting apparatus 2000. In some implementation, the output information may indicate the obstacles detected by the obstacle detecting apparatus 2000. Specifically, for each of the objects that are determined to be obstacle, the output information may include the second subset that corresponds to the object.

Alternatively or additionally, the output information may include the obstacle candidate set from which the outliers (i.e., the objects whose heights are larger than the height threshold) are already removed. In this case, the determination of whether or not each object in the obstacle candidate set is obstacle may be performed by not the obstacle detecting apparatus 2000 but another apparatus that acquires the output information.

There may be various ways to output the output information. For example, the obstacle detecting apparatus 2000 may save the output information on a storage unit. In another example, the obstacle detecting apparatus 2000 may send the output information to arbitrary apparatus. In another example, the obstacle detecting apparatus 2000 may output the output information to a display device so that the contents of the output information is displayed on the display device.

### Example Application of Obstacle Detection

The result of the detection of obstacles may be used to provide an alert to a person who is approaching an obstacle. Hereinafter, an apparatus that provides this alert is called “alerting apparatus”.

The alerting apparatus may repeatedly acquire information, called “person location information” that indicates a current location of a target person to trace the location of the target person. In addition, the alerting apparatus acquires information, called “obstacle information”, that indicates location of each obstacle that is detected by the obstacle detecting apparatus 2000.

In response to the person location information being acquired, the alerting apparatus determines whether or not the target person is approaching an obstacle based on the obstacle information and a time series of person location information. For example, the alerting apparatus may determine a direction of travel of the target person based on a time series of the person location information. When there is an obstacle in the determined direction from the current location of the target person and the distance between the location of the obstacle and the current location of the target person is less than a predefined threshold, the alerting apparatus determines that the target person is approaching the obstacle. Otherwise, the alerting apparatus determines that the target person is not approaching an obstacle.

When it is determined that the target person is approaching an obstacle, the alerting apparatus provides alert information to the target person. The alert information may be any information that is helpful for the target person to avoid the obstacle that the target person is approaching. For example, the alert information may indicate the location of the obstacle, a type of the obstacle (e.g., step or pipe), or the height of the obstacle.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### SUPPLEMENTARY NOTES

### (Supplementary Note 1)

An obstacle detecting apparatus comprising:
at least one memory that is configured to store instructions; and
at least one processor that is configured to execute the instructions to:
acquire a position data set that includes a plurality of position data that indicates a three-dimensional position of a point of a target place;
detect a first subset from the position data set, the first subset including a plurality of the position data that collectively represent a ground of the target place;
determine a vertical position of the ground based on vertical positions indicated by the plurality of position data in the first subset;
detect one or more objects from the position data set to generate an obstacle candidate set;
compute, for each object in the obstacle candidate set, a height of the object based on a vertical position of the object and the vertical position of the ground; and
exclude the object whose height is larger than a height threshold from the obstacle candidate set.

### (Supplementary Note 2)

The obstacle detecting apparatus according to supplementary note 1,
wherein the determination of the vertical position of the ground includes:
   computing, as the vertical position of the ground, a statistical value of vertical positions indicated by the plurality of position data in the first subset.

### (Supplementary Note 3)

The obstacle detecting apparatus according to supplementary note 1 or 2,
wherein the determination of the vertical position of the ground includes:
   dividing the ground into two or more sections; and
   computing, for each section of the ground, the vertical position of the section based on vertical positions indicated by the plurality of position data that collectively represent the section.

### (Supplementary Note 4)

The obstacle detecting apparatus according to supplementary note 3,
wherein the division of the ground includes:
   determining a lowest vertical position and a highest vertical position indicated by the plurality of the position data in the first subset;
   dividing a range between the lowest vertical position and the highest vertical position by a predefined interval into two or more height ranges; and
   dividing the first subset into two or more subsets that represent different sections of the ground from each other based on the two or more height ranges.

### (Supplementary Note 5)

The obstacle detecting apparatus according to supplementary note 4,
wherein the predefined interval is proportional to the height threshold.

### (Supplementary Note 6)

The obstacle detecting apparatus according to supplementary note 1 or 2,
wherein the detection of the one or more objects includes:
   determining a partial area of the target place based on a region of the ground in top view; and
   detecting the one or more objects from a set of a plurality of the position data that indicates a position included in the partial area.

### (Supplementary Note 7)

An obstacle detecting method performed by a computer, comprising:
acquiring a position data set that includes a plurality of position data that indicates a three-dimensional position of a point of a target place;
detecting a first subset from the position data set, the first subset including a plurality of the position data that collectively represent a ground of the target place;
determining a vertical position of the ground based on vertical positions indicated by the plurality of position data in the first subset;
detecting one or more objects from the position data set to generate an obstacle candidate set;
computing, for each object in the obstacle candidate set, a height of the object based on a vertical position of the object and the vertical position of the ground; and
excluding the object whose height is larger than a height threshold from the obstacle candidate set.

### (Supplementary Note 8)

The obstacle detecting method according to supplementary note 7,
wherein the determination of the vertical position of the ground includes:
   computing, as the vertical position of the ground, a statistical value of vertical positions indicated by the plurality of position data in the first subset.

### (Supplementary Note 9)

The obstacle detecting method according to supplementary note 7 or 8,
wherein the determination of the vertical position of the ground includes:
   dividing the ground into two or more sections; and
   computing, for each section of the ground, the vertical position of the section based on vertical positions indicated by the plurality of position data that collectively represent the section.

### (Supplementary Note 10)

The obstacle detecting method according to supplementary note 9,
wherein the division of the ground includes:
   determining a lowest vertical position and a highest vertical position indicated by the plurality of the position data in the first subset;
   dividing a range between the lowest vertical position and the highest vertical position by a predefined interval into two or more height ranges; and
   dividing the first subset into two or more subsets that represent different sections of the ground from each other based on the two or more height ranges.

### (Supplementary Note 11)

The obstacle detecting method according to supplementary note 10,
wherein the predefined interval is proportional to the height threshold.

### (Supplementary Note 12)

The obstacle detecting method according to supplementary note 7 or 8,
wherein the detection of the one or more objects includes:
   determining a partial area of the target place based on a region of the ground in top view; and
   detecting the one or more objects from a set of a plurality of the position data that indicates a position included in the partial area.

### (Supplementary Note 13)

A non-transitory computer readable storage medium storing a program that causes a computer to execute:
acquiring a position data set that includes a plurality of position data that indicates a three-dimensional position of a point of a target place;
detecting a first subset from the position data set, the first subset including a plurality of the position data that collectively represent a ground of the target place;
determining a vertical position of the ground based on vertical positions indicated by the plurality of position data in the first subset;
detecting one or more objects from the position data set to generate an obstacle candidate set;
computing, for each object in the obstacle candidate set, a height of the object based on a vertical position of the object and the vertical position of the ground; and
excluding the object whose height is larger than a height threshold from the obstacle candidate set.

### (Supplementary Note 14)

The storage medium according to supplementary note 13,
wherein the determination of the vertical position of the ground includes:
   computing, as the vertical position of the ground, a statistical value of vertical positions indicated by the plurality of position data in the first subset.

### (Supplementary Note 15)

The storage medium according to supplementary note 13 or 14,
wherein the determination of the vertical position of the ground includes:
   dividing the ground into two or more sections; and
   computing, for each section of the ground, the vertical position of the section based on vertical positions indicated by the plurality of position data that collectively represent the section.

### (Supplementary Note 16)

The storage medium according to supplementary note 15,
wherein the division of the ground includes:
   determining a lowest vertical position and a highest vertical position indicated by the plurality of the position data in the first subset;
   dividing a range between the lowest vertical position and the highest vertical position by a predefined interval into two or more height ranges; and
   dividing the first subset into two or more subsets that represent different sections of the ground from each other based on the two or more height ranges.

### (Supplementary Note 17)

The storage medium according to supplementary note 16,
wherein the predefined interval is proportional to the height threshold.

### (Supplementary Note 18)

The storage medium according to supplementary note 13 or 14,
wherein the detection of the one or more objects includes:
   determining a partial area of the target place based on a region of the ground in top view; and
   detecting the one or more objects from a set of a plurality of the position data that indicates a position included in the partial area.

### REFERENCE SIGNS LIST

10 target place
20 position data set
22 position data
30 ground
40 predefined window
1000 computer
1020 bus
1040 processor
1060 memory
1080 storage device
1100 input/output interface
1120 network interface
2000 obstacle detecting apparatus
2020 acquiring unit
2040 ground level determining unit
2060 object detecting unit
2080 outlier excluding unit

What is claimed is:

1. An obstacle detecting apparatus comprising:
at least one memory that is configured to store instructions; and
at least one processor that is configured to execute the instructions to:
acquire a position data set that includes a plurality of position data that indicates a three-dimensional position of a point of a target place;
detect a first subset from the position data set, the first subset including a plurality of the position data that collectively represent a ground of the target place;
determine a vertical position of the ground based on vertical positions indicated by the plurality of position data in the first subset;
detect one or more objects from the position data set to generate an obstacle candidate set;
compute, for each object in the obstacle candidate set, a height of the object based on a vertical position of the object and the vertical position of the ground; and
exclude the object whose height is larger than a height threshold from the obstacle candidate set.

2. The obstacle detecting apparatus according to claim 1,
wherein the determination of the vertical position of the ground includes:
computing, as the vertical position of the ground, a statistical value of vertical positions indicated by the plurality of position data in the first subset.

3. The obstacle detecting apparatus according to claim 1,
wherein the determination of the vertical position of the ground includes:
dividing the ground into two or more sections; and
computing, for each section of the ground, the vertical position of the section based on vertical positions indicated by the plurality of position data that collectively represent the section.

4. The obstacle detecting apparatus according to claim 3,
wherein the division of the ground includes:
determining a lowest vertical position and a highest vertical position indicated by the plurality of the position data in the first subset;
dividing a range between the lowest vertical position and the highest vertical position by a predefined interval into two or more height ranges; and
dividing the first subset into two or more subsets that represent different sections of the ground from each other based on the two or more height ranges.

5. The obstacle detecting apparatus according to claim 4,
wherein the predefined interval is proportional to the height threshold.

6. The obstacle detecting apparatus according to claim 1,
wherein the detection of the one or more objects includes:
determining a partial area of the target place based on a region of the ground in top view; and
detecting the one or more objects from a set of a plurality of the position data that indicates a position included in the partial area.

7. An obstacle detecting method performed by a computer, comprising:
acquiring a position data set that includes a plurality of position data that indicates a three-dimensional position of a point of a target place;
detecting a first subset from the position data set, the first subset including a plurality of the position data that collectively represent a ground of the target place;
determining a vertical position of the ground based on vertical positions indicated by the plurality of position data in the first subset;
detecting one or more objects from the position data set to generate an obstacle candidate set;
computing, for each object in the obstacle candidate set, a height of the object based on a vertical position of the object and the vertical position of the ground; and
excluding the object whose height is larger than a height threshold from the obstacle candidate set.

8. The obstacle detecting method according to claim 7,
wherein the determination of the vertical position of the ground includes:
computing, as the vertical position of the ground, a statistical value of vertical positions indicated by the plurality of position data in the first subset.

9. The obstacle detecting method according to claim 7,
wherein the determination of the vertical position of the ground includes:
dividing the ground into two or more sections; and
computing, for each section of the ground, the vertical position of the section based on vertical positions indicated by the plurality of position data that collectively represent the section.

10. The obstacle detecting method according to claim 9,
wherein the division of the ground includes:
determining a lowest vertical position and a highest vertical position indicated by the plurality of the position data in the first subset;
dividing a range between the lowest vertical position and the highest vertical position by a predefined interval into two or more height ranges; and
dividing the first subset into two or more subsets that represent different sections of the ground from each other based on the two or more height ranges.

11. The obstacle detecting method according to claim 10,
wherein the predefined interval is proportional to the height threshold.

12. The obstacle detecting method according to claim 7,
wherein the detection of the one or more objects includes:
determining a partial area of the target place based on a region of the ground in top view; and
detecting the one or more objects from a set of a plurality of the position data that indicates a position included in the partial area.

13. A non-transitory computer readable storage medium storing a program that causes a computer to execute:
acquiring a position data set that includes a plurality of position data that indicates a three-dimensional position of a point of a target place;
detecting a first subset from the position data set, the first subset including a plurality of the position data that collectively represent a ground of the target place;
determining a vertical position of the ground based on vertical positions indicated by the plurality of position data in the first subset;
detecting one or more objects from the position data set to generate an obstacle candidate set;
computing, for each object in the obstacle candidate set, a height of the object based on a vertical position of the object and the vertical position of the ground; and
excluding the object whose height is larger than a height threshold from the obstacle candidate set.

14. The storage medium according to claim 13,
wherein the determination of the vertical position of the ground includes:
computing, as the vertical position of the ground, a statistical value of vertical positions indicated by the plurality of position data in the first subset.

15. The storage medium according to claim 13-er 14,
wherein the determination of the vertical position of the ground includes:
dividing the ground into two or more sections; and
computing, for each section of the ground, the vertical position of the section based on vertical positions indicated by the plurality of position data that collectively represent the section.

16. The storage medium according to claim 15,
wherein the division of the ground includes:
determining a lowest vertical position and a highest vertical position indicated by the plurality of the position data in the first subset;
dividing a range between the lowest vertical position and the highest vertical position by a predefined interval into two or more height ranges; and
dividing the first subset into two or more subsets that represent different sections of the ground from each other based on the two or more height ranges.

17. The storage medium according to claim 16,
wherein the predefined interval is proportional to the height threshold.

18. The storage medium according to claim 13,
wherein the detection of the one or more objects includes:
determining a partial area of the target place based on a region of the ground in top view; and
detecting the one or more objects from a set of a plurality of the position data that indicates a position included in the partial area.
